(19) United States
(12) Patent Application Publication
(10) Pub. No.: US 2026/0265862 A1
(43) Pub. Date: Sep. 10, 2026

(54) HEAP LEACHING OF COPPER SULPHIDE ORES

(71) Applicant: MINTEK, Randburg (ZA)

(72) Inventors: Stefan Walters Robertson, Randburg (ZA); Petrus Basson, Randburg (ZA); Mpumelelo Success Ndhlalose, Randburg (ZA); Duduzile Nontobeko Nxumalo, Randburg (ZA)

(21) Appl. No.: 19/556,605

(22) Filed: Mar. 4, 2026

(30) Foreign Application Priority Data
Mar. 4, 2025 (ZA) 202501924

(51) Int. Cl. C22B 15/00; C22B 1/16; C22B 3/08; C25C 1/12

(52) U.S. Cl. CPC C22B 15/0071; C22B 1/16; C22B 3/08; C25C 1/12

(57) ABSTRACT

A method is provided for heap leaching refractory primary copper sulphide ore comprising run-of-mine (ROM) ore and/or crushed ore. The ore is stacked to form a heap and irrigated with a chloride-containing leach solution comprising sulphuric acid and dissolved copper, wherein the leach solution includes raffinate from a downstream solvent extraction and electrowinning (SX/EW) copper recovery process. At least a portion of the leach solution is externally heated prior to irrigation to maintain an elevated temperature within the heap during leaching. Irrigation is conducted at an average rate of less than or equal to 0.5 L/m²/h and may be continuous and/or intermittent, including irrigation and rest cycles.

### CROSS REFERENCE TO RELATED APPLICATION

The present application claims priority to South Africa Patent Application No. 2025/01924, filed Mar. 4, 2025, the entire contents of which are herein incorporated by reference.

### BACKGROUND OF THE INVENTION

The invention relates to the heap leaching of ores, particularly refractory primary copper sulphide ores such as bornite, carrollite, chalcopyrite, cubanite, enargite, tennantite and tetrahedrite.

Approximately 70% of the world's copper reserves occur in the form of low-grade chalcopyrite (CuFeS₂), but much of it is not currently recoverable since chalcopyrite is refractory to hydrometallurgical treatment at ambient conditions due to passivation of the mineral surface. The passivation effect is however overcome by leaching at higher temperatures.

Microbial-assisted heap leaching processes have been developed in which temperature within the heap is raised through exothermic microbial oxidation of sulphide minerals, particularly pyrite, combined with manipulation of irrigation and aeration rates. Although microbial self-heating has been demonstrated on pilot scale, it has been subject to a number of problems, including poor air permeability, long pH reduction periods, the need for microbial succession, insufficient pyrite in the ore, and the negative effect of high sulphate concentrations and impurities such as chloride on microbial activity.

Commercial and semi-commercial high-temperature bioleach processes have been reported, including Terrafame at Sotkamo, Finland (Arpalahti and Lundström, 2019), and elevated-temperature systems such as Rio Tinto's Nuton™ technology, which claims recoveries of up to 85% from primary copper sulphide ores through elevated temperature biological leaching with aeration. However, such processes generally require temperatures above approximately 55° C. and pH values below about 3, resulting in increased acid consumption, stringent operational control requirements, and significant capital and operating costs.

Heap leaching of copper sulphides has also been performed in acidic chloride media, in which both Cu(II)/Cu(I) and Fe(III)/Fe(II) function as oxidation couples. An acidic chloride heap leach process such as BHP's SAL process (Simple Approach to Leaching) is described in WO2015059551. The SAL process employs a single leach circuit and builds up chloride concentrations to levels exceeding 40 g/L, for example from dissolution of atacamite (Cu₂Cl(OH)₃) in the ore. These systems primarily target secondary sulphide copper minerals.

Chloride addition during agglomeration has been disclosed in Chilean Patent 40891, and in subsequent developments such as U.S. Pat. No. 6,926,753 B2, (which form the basis of the Cuprochlor® process). In these processes, agglomeration is typically performed using CaCl₂) and sulphuric acid, followed by irrigation with copper-rich solution. High copper feed concentrations, typically about 5 g/L Cu, are maintained by recycling pregnant leach solution (PLS) or intermediate leach solution (ILS) over the heap.

The Cuprochlor-T® process, described for example in US 2017/0335428 A1, operates at temperatures between approximately 30° C. and 70° C. and claims copper recoveries exceeding 70% after extended leach periods. Agglomeration is performed with CaCl₂) and ILS, and coarse crush sizes (for example 80%-12 mm to 80%-3 mm) are recommended. However, such processes generally rely on high copper concentrations in solution (approximately 5 g/L or greater), resulting in significant copper inventory within the circulating solution. Furthermore, high chloride concentrations, for example 100-190 g/L in certain SAL implementations (Rautenbach, 2015), may be required where heating is not applied, increasing reagent costs.

A chloride heap leach process with semi-autogenous heating is described in WO 2025/012848 A2. In that process, agglomeration is performed with heated brine and chloride salts, followed by curing during which temperature rises to between 40° C. and 60° C. due to exothermic reactions in the heap. The heap is then irrigated continuously at relatively high irrigation rates (6-12 L/m²/h) with heated intermediate leach solution. However, semi-autogenous heating is inherently dependent on internal exothermic reactions and may not permit sustained and controlled temperature management over extended leach periods. High irrigation flowrates further increase thermal duty and capital costs where solution heating is employed.

Irrigation-rest cycles have also been described in acidic chloride heap leaching and historically in copper dump leaching (U.S. Pat. No. 3,868,439). During rest periods, solution retained by capillary forces redistributes and drains. While such cycles may improve drainage and solution distribution, they do not in themselves address limitations associated with high copper recycle inventory, heating of large solution volumes, or treatment of ores with poor permeability or finely disseminated target minerals.

Solar heating has been proposed for heap leaching, for example in U.S. Pat. No. 6,743,276 B1 and WO 2007/140554 A1. In such systems, barren solution or make-up water is heated using solar collectors prior to irrigation. However, conventional irrigation rates used in copper heap leaching, typically between 5 and 15 L/m²·h and in some cases up to 100 L/m²·h, require heating of substantial solution volumes. At such flowrates, the capital cost of installing sufficient solar capacity to heat the entire irrigant stream to temperatures suitable for chalcopyrite dissolution is economically prohibitive. Furthermore, published solar-assisted processes do not consistently disclose the specific chloride-based solution chemistries required for dissolution of refractory chalcopyrite at temperatures above approximately 40° C.

Existing elevated-temperature chloride and bioleach processes therefore exhibit several practical and economic constraints. These include:
(a) high capital costs associated with heating large volumes of irrigation solution;
(b) high copper recycle inventory resulting from elevated copper concentrations in solution;
(c) significant acid consumption associated with low pH operation in bioleach systems;
(d) reliance on specific chloride salts such as CaCl₂) for agglomeration;
(e) requirement for high chloride concentrations when heating is not applied; and
(f) limited suitability for ores with poor permeability or finely disseminated sulphide minerals.

Furthermore, processes that depend on semi-autogenous heating or microbial heat generation do not allow sustained and precisely controlled temperature profiles throughout the heap over prolonged leach cycles.

Accordingly, there remains a need for an improved heap leaching process capable of economically treating chalcopyrite-containing ores, including ores with limited permeability or finely disseminated sulphides, while reducing copper inventory, acid consumption, and heating-related capital costs, and while providing improved control over temperature and solution chemistry during leaching.

### SUMMARY OF INVENTION

The invention provides a method for heap leaching a refractory primary copper sulphide ore, the ore comprising Run-Of-Mine (ROM) ore and/or crushed ore, the method including:
a) stacking the ore to form a heap;
b) irrigating the heap with a leach solution comprising chloride at a concentration of 20 g/L to 90 g/L, sulphuric acid at a concentration of 0 g/L to 50 g/L and dissolved copper at a concentration of 0.1 g/L to 1 g/L;
c) wherein the leach solution comprises raffinate from a downstream solvent extraction and electrowinning (SX/EW) copper recovery process;
d) externally heating at least a portion of the leach solution prior to irrigation such that a temperature within the heap is maintained in the range of 30° C. to 50° C. during leaching; and
wherein irrigation in step (b) is conducted at an average irrigation rate of less than or equal to 0.5 L/m²/h, the irrigation comprising continuous irrigation and/or intermittent irrigation including irrigation and rest cycles.

The refractory primary copper sulphide minerals may comprise one or more of chalcopyrite, bornite, carrollite, cubanite, enargite, tennantite and tetrahedrite. The ore may be stacked onto a pad with an impermeable base.

If crushed ore is used, the material may have a particle size of 12.5 mm or less (100% passing 12.5 mm). Alternatively uncrushed ROM waste ore is stacked into a pile.

Preferably the leach solution has a dissolved copper concentration of less than 0.5 g/L to reduce copper inventory in the heap and reduce line blockages from precipitates.

The leach solution may comprise raffinate, process water, brine (e.g. produced from reverse osmosis of seawater) or seawater or a combination thereof to which the chloride and sulphuric acid (H₂SO₄) are added.

The chloride may be added as a suitable chloride salt selected from NaCl, MgCl₂, KCl, AlCl₃ or mixtures thereof.

The leach solution may contain dissolved iron in an amount of 0 g/L to 20 g/L total iron. The iron may be Fe(II) and/or Fe(III).

The leach solution may be heated by solar heating. The solar heating may include a solar field and a heat exchanger and/or heat pump configured to heat the leach solution before irrigation.

Heat loss from the heap may be reduced by applying a thermal cover and/or an insulating cover over at least a portion of the heap. Additionally, the irrigation lines or drippers may be buried in or under the heap to reduce evaporative and conductive heat loss.

The average irrigation rate of 0.5 L/m²/h may be achieved by irrigation-rest cycling wherein irrigation is carried out at a rate of less than 1 L/m²/h for an irrigation cycle of 24 hours or 12 hours followed by a rest cycle of 24 hours or 12 hours.

The method may be carried out without an agglomeration step.

The method may include an optional agglomeration step including agglomerating crushed ore prior to stacking the ore to form a heap with a chloride salt at 0 kg/t to 50 kg/t and sulphuric acid at 0 kg/t to 50 kg/t and adding water and/or raffinate, seawater, brine or process water to form agglomerates.

The agglomerated ore may be cured for a period of 7 to 30 days prior to irrigation.

### DESCRIPTION OF THE DRAWINGS

The invention is further described by way of example with reference to the accompanying drawings in which:

FIG. 1 illustrates a flowsheet representation of a prior art method for heap leaching of copper.

FIG. 2 illustrates a flowsheet representation of a method according to the invention.

FIG. 2A illustrates a flowsheet representation of a method according to the invention with an optional agglomeration step.

FIG. 3 is a comparison plot of copper dissolution profiles as a function of temperature.

FIG. 4 is a comparison plot of drainage pH profiles for H1, H2 and H3 according to an example of the invention.

FIG. 5 is a comparison plot of drainage Fe (T) profiles for H1, H2 and H3 according to an example of the invention.

FIG. 6 is a comparison plot of copper dissolution vs irrigation ratios.

FIG. 7 is a comparison plot of copper dissolution over time.

FIG. 8 is a comparison plot of copper drainage concentration profiles over time according to examples of the invention.

FIG. 9 is a comparison plot of net acid consumption vs copper dissolution.

FIG. 10 is a plot of copper extraction showing the effect of leach solution (lixiviant) acid concentration.

FIG. 11 is a plot of net acid consumption over time showing the effect of leach solution (lixiviant) acid concentration.

FIG. 12 is plot of copper dissolution showing the effect of agglomeration on copper dissolution profiles.

FIG. 13 is a plot of copper dissolution profiles showing the effect of chloride concentration.

FIG. 14 is a plot of copper dissolution profiles showing the effect of chloride concentration and cement agglomeration.

FIG. 15 is a plot of copper dissolution profiles showing the effect of aeration.

### DESCRIPTION OF PREFERRED EMBODIMENTS

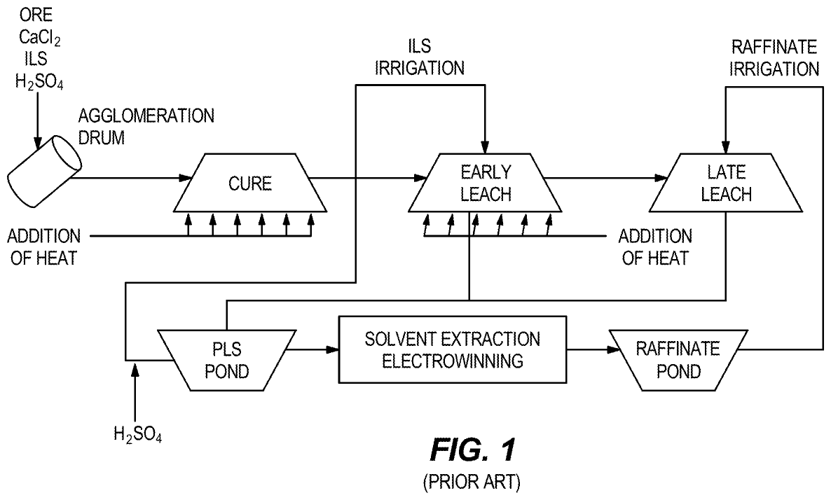

FIG. 1 illustrates a heap leach process according to the prior art, for example the method proposed is US2017/0335428A1. In the prior art method, the ore is agglomerated in an acid chloride medium and is allowed to cure before leaching. Intermediate leach solution is used to irrigate the heap, and the leaching is carried out in two steps comprising an early leach and a late leach.

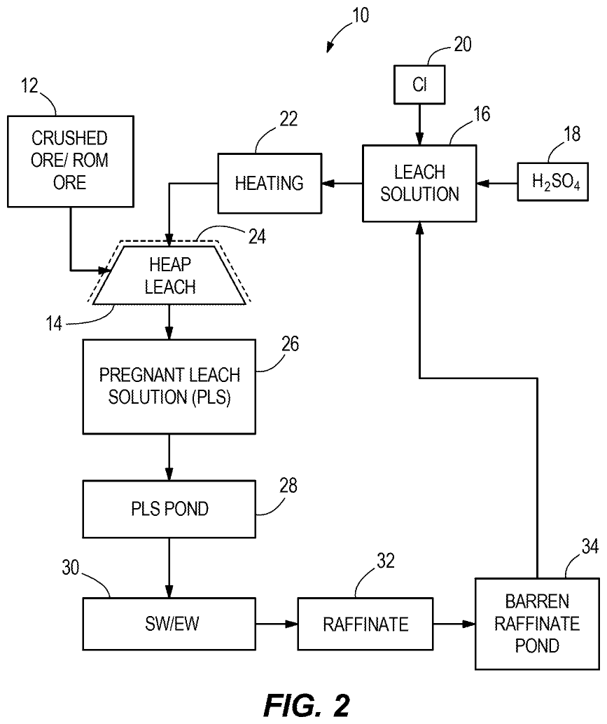

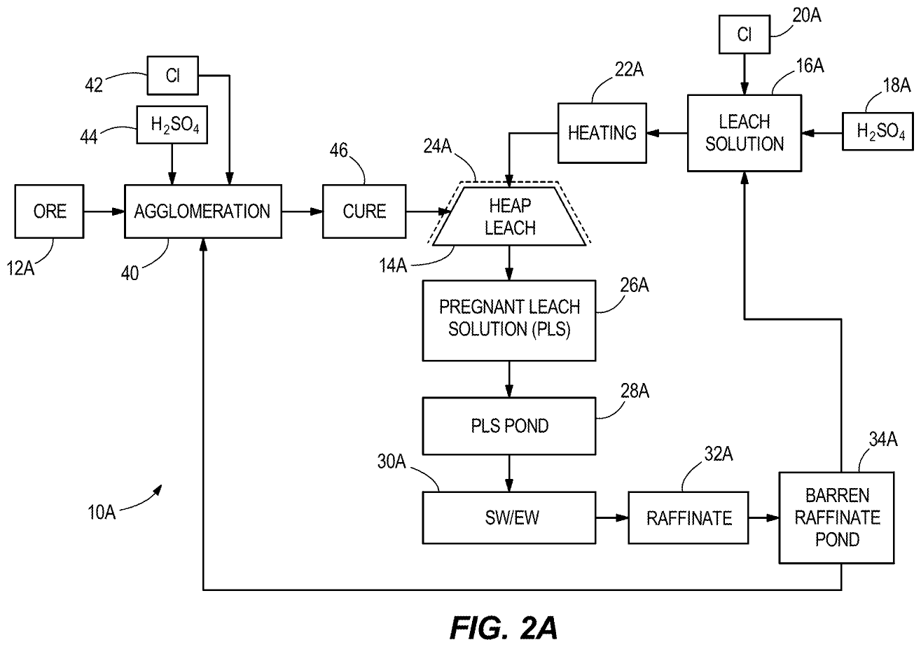

A method of heap leaching 10 according to the present invention is illustrated in FIG. 2. In a first step, crushed ore, having a particle size of 12.5 mm or less (100% passing 12.5 mm), or ROM ore 12, is stacked to form a heap 14 on a pad with an impermeable base.

The heap 14 is irrigated with a leach solution 16 comprising a raffinate solution 32 from a barren pond 34, process water, brine (e.g. produced from the reverse osmosis of seawater) or seawater, to which is added H₂SO₄ 18 in an amount of 0-50 g/L and a chloride salt 20 in the amount of 20-90 g/L. The chloride salt is selected from NaCl, MgCl₂, KCl, AlCl₃ or mixtures thereof. The leach solution (lixiviant) 16 contains low levels of copper (0.1-1 g/L), Cl (20-90 g/L), Fe (0-20 g/L) and H₂SO₄ (0-50 g/L). Preferably, the leach solution contains 0.5 g/L copper, 30-50 g/L chloride, 2 g/L Fe and 5 g/L H₂SO₄.

Prior to irrigation, external heating 22 is applied to the leach solution 16 to achieve elevated temperatures in the heap 14 of 30° C. to 50° C., and preferably 40° C. External heating 22 is achieved by means of solar heating, steam heating or other suitable heating systems. If solar heating is applied, a solar field comprising solar heating panels or collectors with a DC/AC converter and a heat pump or heat exchanger are used to heat the leach solution 16.

To limit heat losses and reduce evaporative losses from the heap 14, the heap is covered with a suitable insulating cover 24, shown in dotted outline. Additionally, drippers (not shown) used in the irrigation are buried to reduce heat losses. Heating of the leach solution 16 results in a substantial reduction in the required chloride concentration in the leach solution 16 (i.e. less than 90 g/L) compared with prior art methods such as BHP's SAL process, which utilizes 150-190 g/L chloride in which heating is not applied.

The heap 14 is irrigated with the heated leach solution 16 at a low irrigation rate of less than or equal to 0.5 L/m²/h continuously, or at a rate of less than 1 L/m²/h, employing irrigation and resting cycles of 24 hours or 12 hours each, which is equivalent to an average irrigation rate of less than or equal to 0.5 L/m²/h.

The use of low irrigation rates (less than 0.5 L/m²/h) substantially reduces the heat load and capital cost of a solar heating plant used to heat the leach solution 16 from an estimated USD 25 million (at a typical irrigation rate of 6 L/m²/h) to below USD 1.5 million for a plant treating 2 million tonnes of ore per annum. The application of low irrigation rates is contrary to conventional practice (e.g. Cuprochlor-T, SAL, Codelco) where high irrigation rates (e.g. 5 to 15 L/m²/h) are used to prevent reagent supply limitation for fast leaching of gold, copper oxide and secondary sulphide ores. However, with slow leaching chalcopyrite ores, this is not necessary.

The leach rate of the method 10 is independent of copper concentration. As such, the method 10 utilizes irrigation with the leach solution 16 with 0.5 g/L copper, rather than 5 g/L copper which is typical of prior art methods which utilise intermediate leach solution for irrigation of the heap. This results in a substantial reduction in the copper inventory over the heap 14, as well as a simpler flowsheet compared to prior art methods and also reduces formation of precipitates blocking the dripper lines.

Drainage from the heap 14, comprising a pregnant leach solution (PLS) 26 reports to the PLS pond 28. The PLS pond 28 feeds a solvent extraction (SX) plant 30 where metals are recovered by means of electro-winning. The resulting raffinate 32 then proceeds to the barren pond 34. The raffinate 32 is recycled for use as leach solution 16 for the irrigation of the heap 14.

Although an agglomeration step is not essential, FIG. 2A illustrates a method 10A, which is the same as the method 10 but includes an optional agglomeration step 40. In the method 10A, ore 12A is mixed with a chloride salt 42 (e.g. NaCl, MgCl₂, KCl, AlCl₃, or mixtures thereof) at concentrations of 0-50 kg/t in an agglomeration drum. Raffinate 32A from the raffinate pond 34A (or seawater or brine or process solution) is added together with H₂SO₄ 44 in the amount of 0-50 kg/t. Following agglomeration 40 the agglomerated ore is allowed to cure 46 for a period of 7 to 30 days. The agglomeration process serves to introduce chloride into the circuit to speed up the initial rate of leaching.

If the ore 12A has poor permeability (i.e. less than 10-15% passing 75 μm) or if the mineral is finely disseminated, an alternative agglomeration process is applied. In this regard the ore is crushed (100% passing 1 mm) and is agglomerated with the addition of modified Ordinary Portland Cement (OPC) in the amount of 0-50 kg/t together with water and is cured for a period of 30 days. Thereafter irrigation is carried out as described in the method 10A.

### EXAMPLES

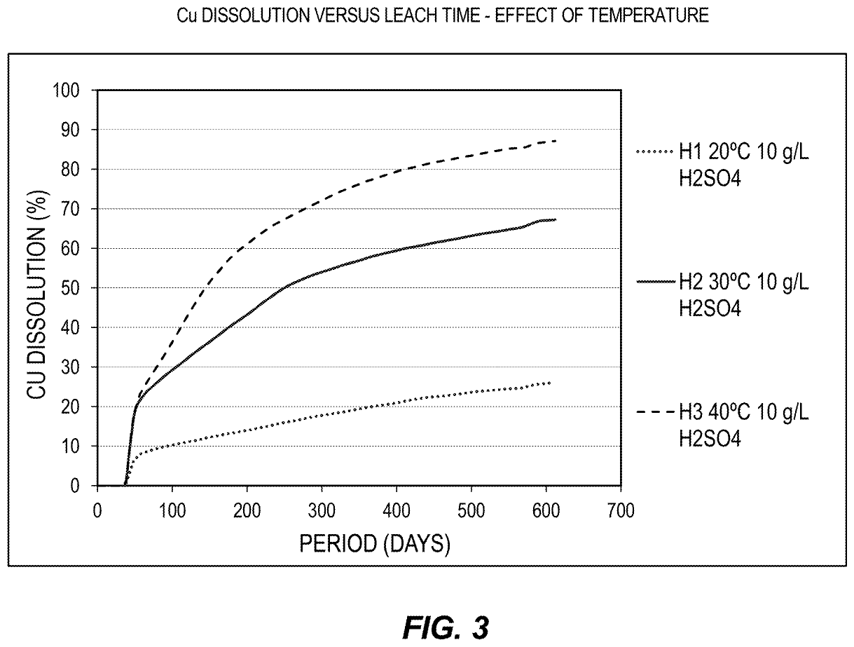

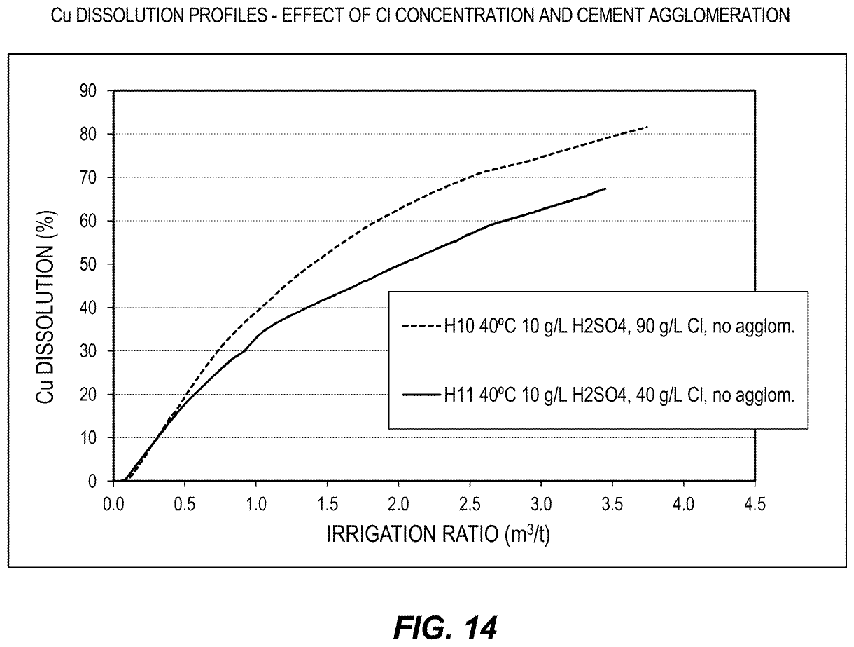

The invention is further described by way of example with reference to Table 1 and accompanying graphs illustrated in FIGS. 3 to 15. Tests were performed on a Southern African chalcopyrite ore (Ore 1) and South American chalcopyrite ores (Ore 2 and Ore 3). The Cu (T) head grades were 1.05% (Ore 1), 0.3% (Ore 2) and 0.28% (Ore 3), with contributions from chalcopyrite of 97.11% (Ore 1), 95.26% (Ore 2) and 99% (Ore 3). Each of the ores were crushed to 100%-6.7 mm.

Tests H1-H9 and H13-H16 were performed with agglomeration, whereas H10 and H11 were performed without agglomeration. Agglomeration was performed by rolling the dry crushed ore on a plastic sheet while mixing in 16 kg/t NaCl as dry solids. Approximately half of the required moisture content was then sprayed on as synthetic raffinate (90 g/L Cl as NaCl, 0.5 g/L Cu as CuSO₄, 10 g/L H₂SO₄, 7 g/L Fe²⁺ as FeSO₄·7H₂O and 3 g/L Fe³⁺ as Fe₂(SO₄)₃·xH₂O). Curing acid (4 kg/t H₂SO₄) was then added as 98% H₂SO₄. Finally, the remaining moisture was added to yield a final moisture content of 4.9%. The agglomerates were loaded into a 1 m tall, 97 mm ID, jacketed polypropylene leach columns, and allowed to cure for 30 days at ambient temperature. After curing, the columns were intermittently irrigated at a rate of 1 L/m²/h (12 h on, 12 h off) with synthetic raffinate containing 1 g/L, 2 g/L, 10 g/L or 20 g/L H₂SO₄, 40 g/L or 90 g/L Cl as NaCl, 7 g/L Fe(II) as FeSO₄·7H₂O and 3 g/L Fe(III) as Fe₂(SO₄)₃·xH₂O. The columns were aerated at 0.08 or 0.3 Nm³/(m²·h). Column temperatures were maintained at 20° C. (H1), 30° C. (H2) or 40° C. (H3) by passing solution from a geyser or chiller through the column mantles.

The effect of temperature was investigated by performing columns H1, H2 and H3 at 20° C., 30° C. and 40° C., respectively, at the base case of 10 g/L H₂SO₄ and 90 g/L Cl in the feed solution. Since 40° C. yielded higher copper dissolution rates, this temperature was used as the base case for subsequent tests (except for H7 and H8). Different feed acid concentrations were tested in H5 (40° C., 20 g/L), H7 (30° C., 2 g/L) and H8 (20° C., 1 g/L), respectively. A lower feed Cl concentration (40 g/L) was also tested in H9 and H11, whereas all other tests were performed at 90 g/L Cl.

The effect of irrigation rate was studied by performing H6 at a lower irrigation rate ((0.5 L/m²/h, 12 h on, 12 h off) and H13 at a higher irrigation rate (12 L/m²/h, 12 h on, 12 h off). All other tests were irrigated at 1 L/m²/h (12 h on, 12 h off). The effect of aeration was studied in H4 (no aeration), H15 (aeration with pure O₂ under controlled conditions) and H16 (supplied with N₂). All other tests were aerated with air using a gas flow controller. The effect of head grade was studied by performing tests H13-H16 on the South American ore type (0.31% Cu) whereas H1-H11 were performed on the Southern African ore (1.05% Cu).

Another test, H12 was performed on a finer crush size, (−1.18 mm) and agglomerated with modified Ordinary Portland Cement (10 kg/t) and water. After curing for 30 days, the sample was irrigated with synthetic raffinate containing 10 g/L H₂SO₄, 40 g/L Cl, 7 g/L Fe(II) and 3 g/L Fe(III).

### Table 1. Summary of Test Conditions

TABLE 1
Summary of test conditions

| | | Crush | | | | | | | |
|---|---|---|---|---|---|---|---|---|---|
| | | size | | | | | Irrigation | [Cl] in | [H₂SO [symbol] |
| | | 100% | Temp. | | | Aeration | Rate | irrigation | irriga [symbol] |
| Test | Ore type | passing | ° C. | Agglomeration | Aeration | kg/m²/h | L/m²/h | g/L | g/ [symbol] |
| H1 | Ore 1 | 6.7 | 20 | Y | Air | 0.3 | 1.0 | 90 | 1 [symbol] |
| H2 | Ore 1 | 6.7 | 30 | Y | Air | 0.3 | 1.0 | 90 | 1 [symbol] |
| H3 | Ore 1 | 6.7 | 40 | Y | Air | 0.3 | 1.0 | 90 | 1 [symbol] |
| H4 | Ore 1 | 6.7 | 40 | Y | No air | 0 | 1.0 | 90 | 1 [symbol] |
| H5 | Ore 1 | 6.7 | 40 | Y | Air | 0.3 | 1.0 | 90 | 2 [symbol] |
| H6 | Ore 1 | 6.7 | 40 | Y | Air | 0.3 | 0.5 | 90 | 1 [symbol] |
| H7 | Ore 1 | 6.7 | 30 | Y | Air | 0.3 | 1.0 | 90 | 2 [symbol] |
| H8 | Ore 1 | 6.7 | 20 | Y | Air | 0.3 | 1.0 | 90 | 1 [symbol] |
| H9 | Ore 1 | 6.7 | 40 | Y | Air | 0.3 | 1.0 | 40 | 1 [symbol] |
| H10 | Ore 1 | 6.7 | 40 | N | Air | 0.3 | 1.0 | 90 | 1 [symbol] |
| H11 | Ore 1 | 6.7 | 40 | N | Air | 0.3 | 1.0 | 40 | 1 [symbol] |
| H12 | Ore 1 | 1.18 | 40 | Y | Air | 0.3 | 1 | 40 | 1 [symbol] |
| H13 | Ore 2 | 6.7 | 40 | Y | Air | 0.08 | 12.0 | 90 | 1 [symbol] |
| H14 | Ore 2 | 6.7 | 40 | Y | Air | 0.08 | 1.0 | 90 | 1 [symbol] |
| H15 | Ore 2 | 6.7 | 40 | Y | Oxygen | 0.08 | 1.0 | 90 | 1 [symbol] |
| H16 | Ore 2 | 6.7 | 40 | Y | Nitrogen | 0.08 | 1.0 | 90 | 1 [symbol] |

1. All tests were performed in 1 m tall, 97 mm ID, jacketed polypropylene leach columns
2. All head samples were crushed to 100% −6.7 mm
3. Agglomeration was performed with 16 kg/t NaCl, 4 kg/t H₂SO₄
4. Agglomeration moisture was added as synthetic raffinate containing 90 g/L Cl, 0.5 g/L Cu, 10 g/L H₂SO₄, 7 g/L Fe(II) and 3 g/L Fe(III).
5. Intermittent irrigation was employed: 12 h on, 12 h off
6. Irrigation with synthetic raffinate containing 0.5 g/L Cu, 3 g/L Fe(III) and 7 g/L Fe(II), 1, 2, 10 or 20 g/L H₂SO₄, 40 or 90 g/L Cl
7. H12 was agglomerated with 10 kg/t modified cement and water, and cured for 30 days [symbol]
indicates data missing or illegible when filed

All tests were performed in 1 m tall, 97 mm ID, jacketed polypropylene leach columns.

All head samples were crushed to 100%-6.7 mm.

Agglomeration was performed with 16 kg/t NaCl, 4 kg/t H₂SO₄.

Agglomeration moisture was added as synthetic raffinate containing 90 g/L 10 Cl, 0.5 g/L Cu, 10 g/L H₂SO₄, 7 g/L Fe(II) and 3 g/L Fe(III).

Intermittent irrigation was employed: 12 h on, 12 h off.

Irrigation was carried out with synthetic raffinate containing 0.5 g/L Cu, 3 g/L Fe(III) and 7 g/L Fe(II), 1, 2, 10 or 20 g/L H₂SO₄, 40 or 90 g/L Cl.

H12 was agglomerated with 10 kg/t modified cement and water, and cured for 30 days.

### Effect of Temperature

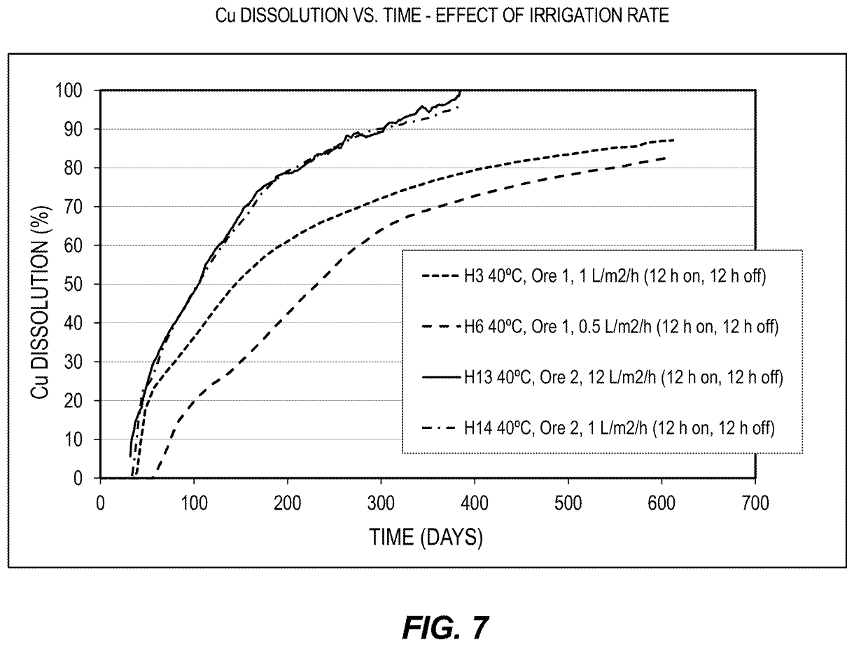

Copper dissolution profiles (Ore 1) as function of temperature are plotted in FIG. 3. The Cu dissolution rates increase strongly with temperature, due to the high activation energy of chalcopyrite. A Cu dissolution of 87.1% was achieved at 40° C. (H3), based on a recalculated head. Dissolution profiles for H1, H2 and H3 were recalculated based on a recalculated head (including head, solution and residue assays), whereas other profiles are based on head and solution assays. Leach cycles for Ore 2 were considerably shorter due to the lower head grades (FIG. 7).

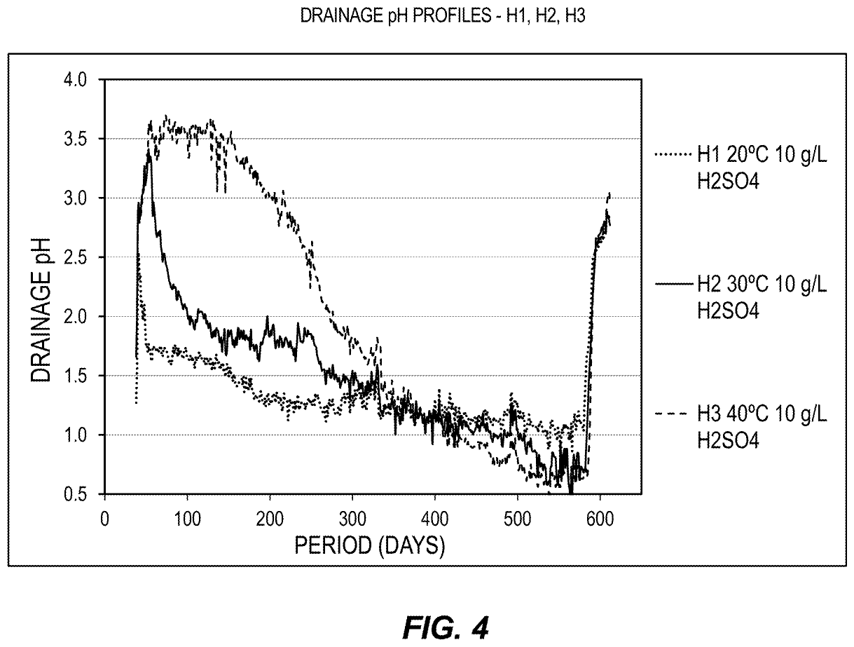

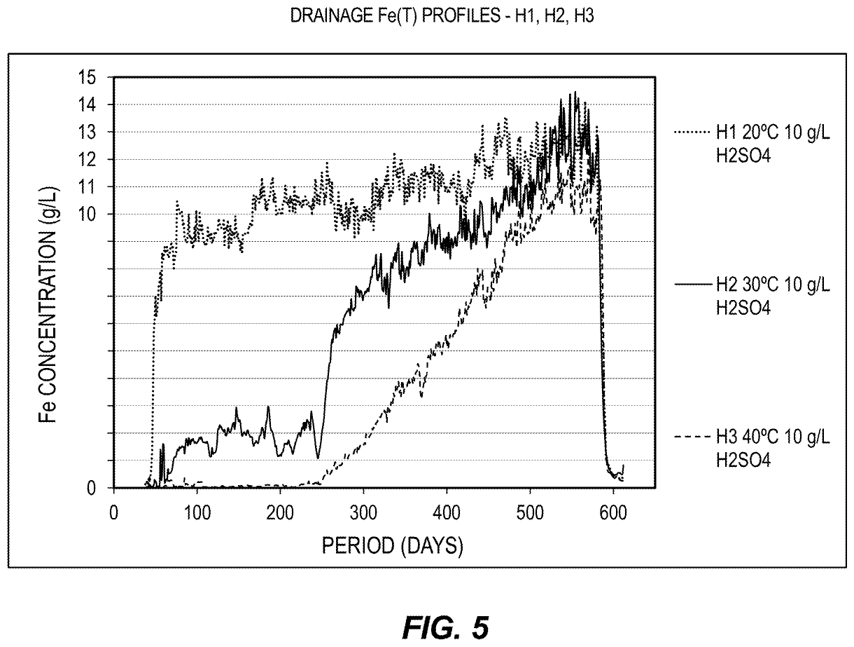

The drainage pH profiles for H1, H2 and H3 are presented in FIG. 4. The drainage pH increases with temperature, corresponding with increased gangue reaction at higher temperatures. This results in initially lower Fe (T) concentrations in the drainages for H3, since the drainage pH was initially below the solubility pH of Fe(III) (<3) (FIG. 5).

Fe (T) only appears in the drainage after about 250 days. One of the benefits of the acidic chloride leach process over bioleaching is that leaching can take place in the absence of Fe at higher pH values (i.e. <4) since the Cu(II)/Cu(I) couple can act as oxidant, even if all the Fe has precipitated out above pH 3. This allows lower irrigation rates to be applied and substantially reduces the acid consumption compared with the bioleach process where higher acid addition rates and irrigation rates are needed to initially reduce the pH to below 3, where, according to Monhemius (2017), Fe(III) becomes soluble.

### Effect of Irrigation Rate

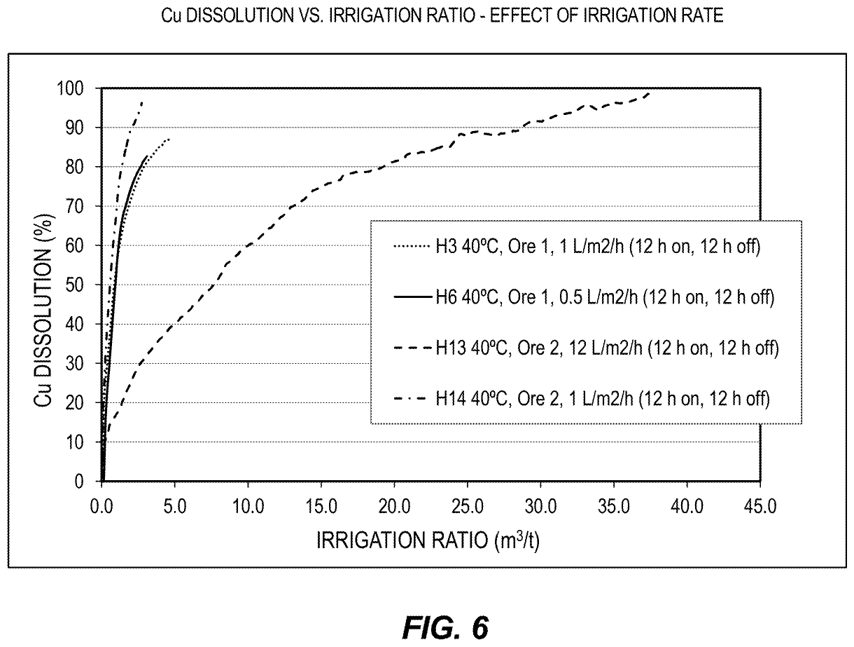

The effect of irrigation rate is shown in FIGS. 6, 7, 8 and 9. H3 (1 L/m²/h, 12 h on, 12 h off) and H6 (0.5 L/m²/h, 12 h on, 12 h off) were performed on Ore 1. Similarly, H13 (12 L/m²/h, 12 h on, 12 h off) and H14 (1 L/m²/h, 12 h on, 12 h off) were performed on Ore 2. FIGS. 6 and 7 show that Cu dissolution rates were independent of irrigation rate for H13 and H14. H6 yielded moderately lower Cu dissolution rates than H3. This suggests that lower irrigation rates may be applied to reduce heating costs. This is counter-intuitive, since conventional heap leach processes use high irrigation rates, combined with addition of reagent in agglomeration to speed up the supply of reagents to the heap (e.g. acid, cyanide, Cu(II)) for fast-leaching gold, copper oxide and secondary sulphide copper ores. However, in the case of chalcopyrite leaching, the rate may be controlled by the slower chalcopyrite mineral surface reaction and not the rate of supply of reagents.

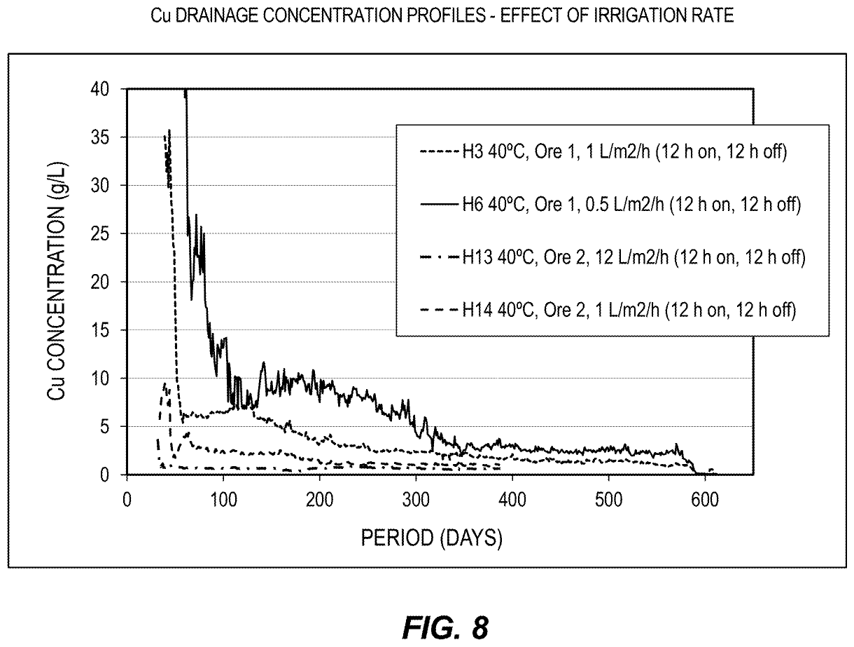

FIG. 8 shows the Cu concentrations in the drainage. Although leach rates were the same for H13 and H14, Cu concentrations in the pregnant leach solution drainage (PLS) were different. This suggests that the leach rate is not a function of the Cu concentration, which allows low Cu feed concentrations to be used.

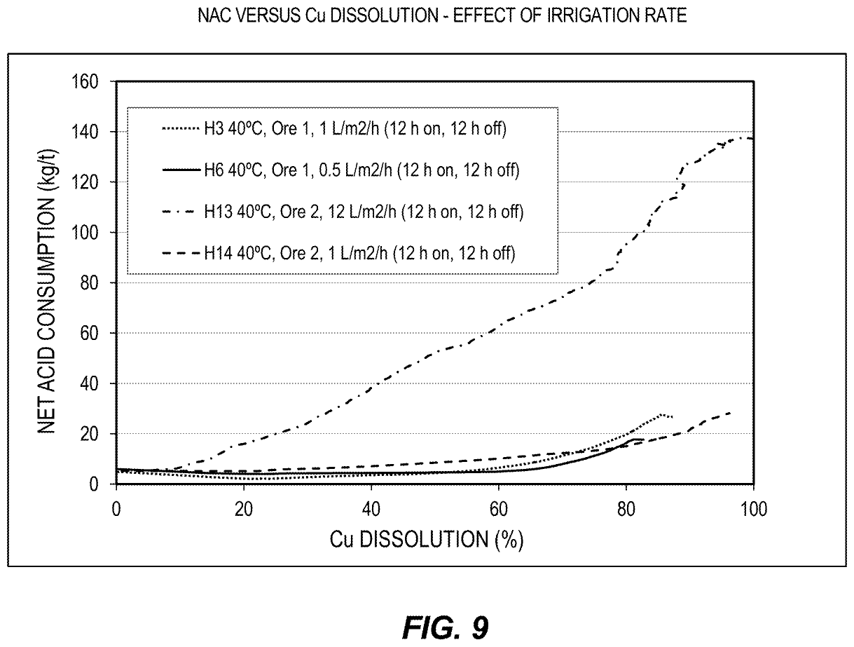

Furthermore, the lower irrigation rate has the benefit of lower net acid consumptions (NAC) (FIG. 9) and reduces the formation of precipitates which may block the dripper lines. In addition, the lower irrigation rate also reduces permeability inhibitions caused by high moisture hold-up which occurs at higher irrigation rates. The larger void space allows better air ingress, gas-solution contact and therefore oxidation of the solutions in the heap.

The lower effective irrigation rate has the benefit of reducing the heat load as indicated in Table 2, since, in the absence of major heat losses from the side or top of the heap, the heat requirement is primarily contributed by the heat capacity of the irrigation solution. For example, for a 2 million tonne per annum heap, costs of installed solar power can be reduced from USD 25 million at a typical irrigation rate of 6 L/(m²·h) to USD 1.5 million for the current invention at an effective irrigation rate of 0.5 L/(m²/h). If the ore has a Cu (T) head grade of 0.5% with an 70% copper dissolution and a copper price of USD 4/lb (2024), this amounts to a revenue of USD 62 million in the first year, and the capital costs of the solar plant can be paid off in the first year. The costs are based on an installed solar cost of ZAR 1 million per 100 KW peak capacity (assume 19 ZAR/USD, 2023 exchange rate), equivalent to 526 USD/KW installed solar costs, as provided by a solar heating supplier, Kinetix (Evans, 2023). The required land surface area is 700 m² per 100 KW peak for photovoltaic cells, and the plant will contain a DC/AC converter and a heap pump or heat exchanger to heat up the irrigation solution. The solution lines will be buried in the ore or underground to minimise heat losses. The cost of the heat exchanger is not included.

TABLE 2
Effect irrigation rate on solar heating costs

| Duration | year | 1 | | | 1 | | | 1 | | |
|---|---|---|---|---|---|---|---|---|---|---|
| Heap area | m² | 185 185 | | | 185 185 | | | 185 185 | | |
| Irrigation rate | L/m²/h | 6.0 | | | 1.0 | | | 0.5 | | |
| Irrigation rate | m³/h | 1 111 | | | 185 | | | 93 | | |
| Density solution | t/m³ | 1.04 | | | 1.04 | | | 1.04 | | |
| Irrigation rate | kg/h | 1 155 556 | | | 192 593 | | | 96 296 | | |
| Heat capacity of water | kJ/kg ° C. | 4.2 | | | 4.2 | | | 4.2 | | |
| Ambient Temperature | ° C. | 15 | 15 | 15 | 15 | 15 | 15 | 15 | 15 | 15 |
| ΔT | ° C. | 15 | 25 | 35 | 15 | 25 | 35 | 15 | 25 | 35 |
| Heap Temperature | ° C. | 30 | 40 | 50 | 30 | 40 | 50 | 30 | 40 | 50 |
| Energy to heat up soln. | MW | 20 | 34 | 47 | 3 | 6 | 8 | 2 | 3 | 4 |
| Energy to heat up soln. | MWh | 177 147 | 295 244 | 413 342 | 29 524 | 49 207 | 68 890 | 14 762 | 24 604 | 34 445 |
| Exchange rate | ZAR/USD | 19 | 19 | 19 | 19 | 19 | 19 | 19 | 19 | 19 |
| Cost install [1] | ZAR/kW | 10 000 | 10 000 | 10 000 | 10 000 | 10 000 | 10 000 | 10 000 | 10 000 | 10 000 |
| Cost to install | USD/kW | 526 | 526 | 526 | 526 | 526 | 526 | 526 | 526 | 526 |
| Cost installed | M USD | 10.6 | 17.7 | 24.8 | 1.8 | 3.0 | 4.1 | 0.9 | 1.5 | 2.1 |

[1] Evans, Kinetix, 2023

### Effect of Acid Concentration in Feed Solution (Lixiviant)

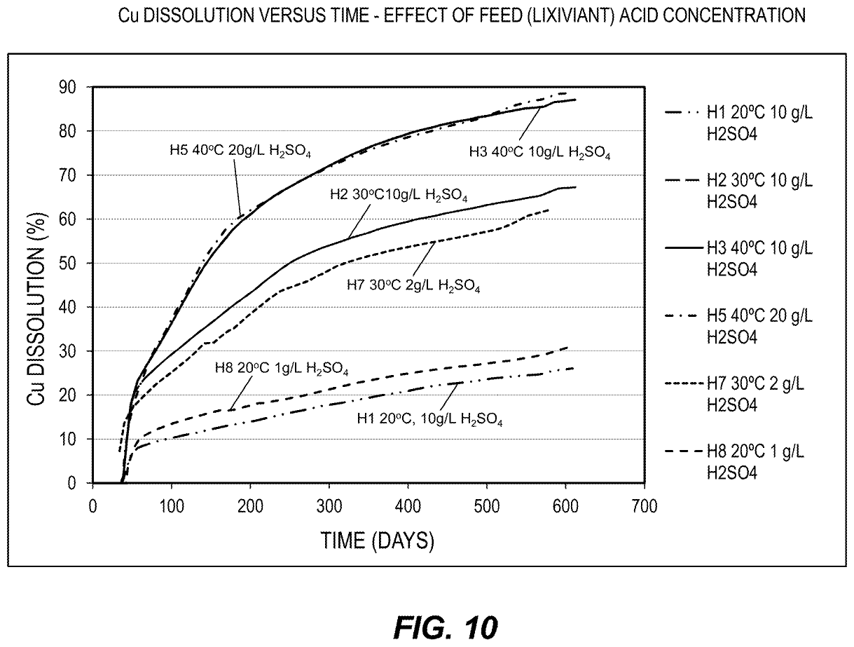

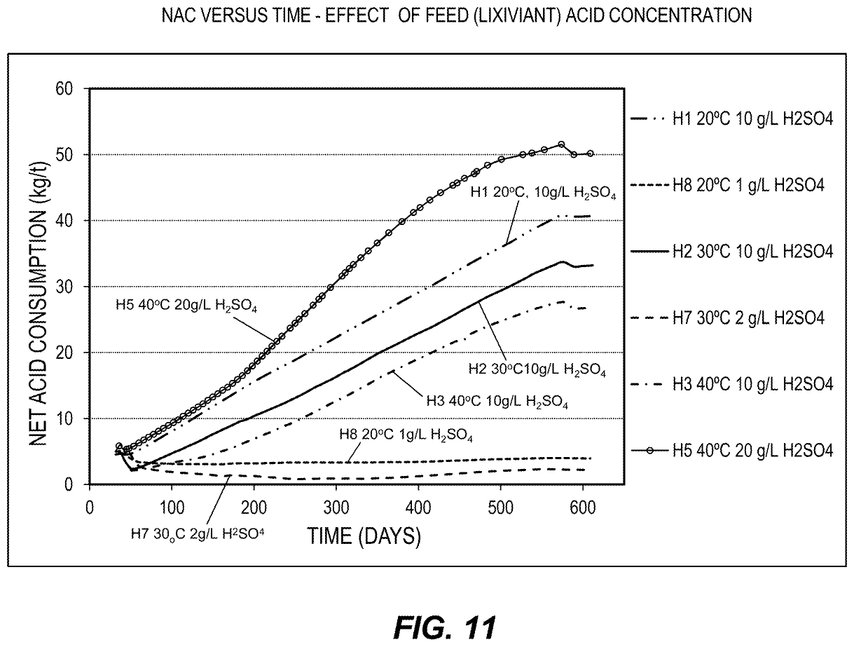

The effect of feed (lixiviant) acid concentration is shown in FIG. 10 (Ore 1). The feed acid concentration did not have a large effect on the rate of Cu dissolution at each temperature. Rather, the leach rate was a stronger function of temperature, due to the high activation energy of the chalcopyrite mineral. FIG. 11 shows that substantial reductions in net acid consumption (NAC) can be achieved by operating at lower feed acid concentrations.

### Effect of Agglomeration

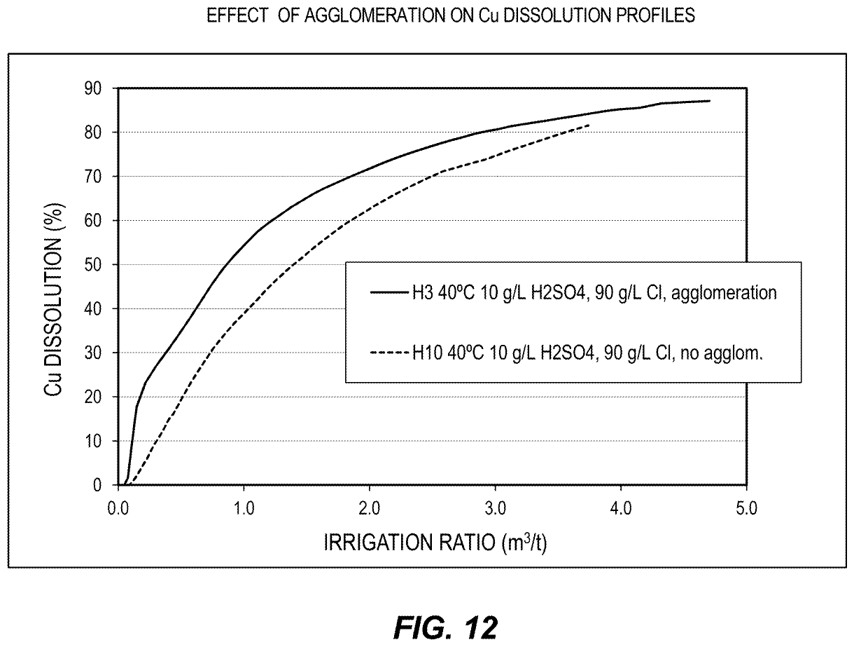

The effect of agglomeration is illustrated in FIG. 12 (Ore 1). H3 was performed with agglomeration and H10 was performed without agglomeration. In the case of agglomeration (H3), the initial irrigation rate was higher. High concentrations of copper and Cl (<250 g/L) occur in solution directly after a curing step, but these are soon washed out. The initial high leach rates observed after agglomeration and curing may be attributed to acid-soluble and cyanide-soluble species or chalcopyrite in small grains reacting in the curing step and washing out during initial irrigation. The high, initial Cu dissolution rate then gave way to slower Cu dissolution rate after 20% dissolution (H3). Column H10 was performed without agglomeration, but at the same irrigation conditions as H3. Although initially slower, the dissolution rate eventually caught up with H10 after 270 days. This suggests that although agglomeration may initially speed up the leach rate, it is not essential.

### Effect of Cl Concentration

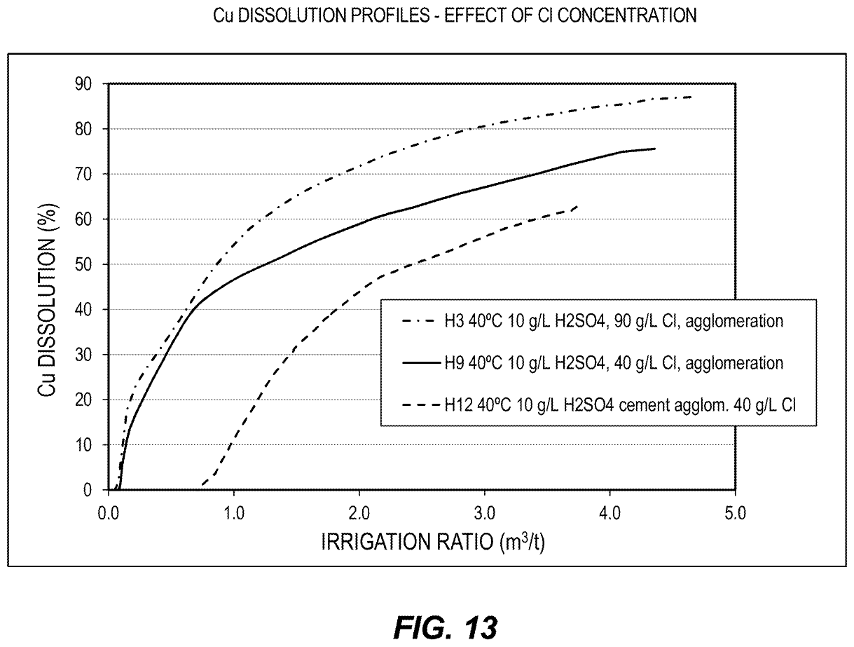

H3 and H9 were performed with the same agglomeration and curing steps, but H3 was irrigated with 90 g/L Cl in the lixiviant (leach solution) and H9 with 40 g/L Cl in the lixiviant. As shown in FIG. 13, H9 yielded lower leach rates after 120 days (irrigation ratio>0.7 m³/t) compared with H3 and maintained a more linear rate. Hence the higher Cl concentration resulted in a faster and higher Cu dissolution rate.

H12 shows the benefit of agglomeration with Pozzolanic cement (OPC modified with furnace dust or flue dust) in generating stable agglomerates from finer ores and waste materials (in this case the sample was crushed to −1.18 mm). Although this column initially showed a pH above 4 in the PLS due to the alkalinity in the cement, resulting in Cu precipitating out, the pH dropped to below 4 after 100 days, followed by a sharp rise in the Cu dissolution profile.

H10 and H11 show the effect of Cl concentration in columns performed with no agglomeration step. H10 (90 g/L) leached faster than H11 (40 g/L), indicating the benefit of higher Cl concentration in the leach solution.

### Effect of Aeration

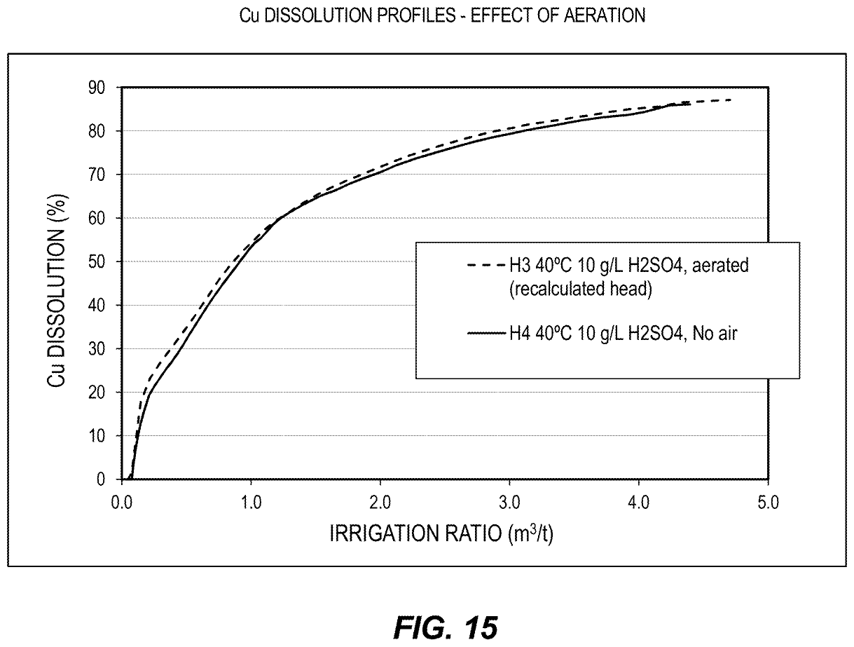

The Cu dissolution profiles of Column H4, performed without forced aeration, is compared in FIG. 15 with H3, performed with aeration, with all other reaction conditions being the same. H4 performed similarly to H3. This suggests that forced aeration is not required for a 1 m lift. However, it is suggested that forced aeration may be necessary for taller lifts.

1. A method for heap leaching a refractory primary copper sulphide ore, the ore comprising Run-Of-Mine (ROM) ore and/or crushed ore, the method comprising:
a) stacking the ore to form a heap;
b) irrigating the heap with a leach solution comprising chloride at a concentration of 20 g/L to 90 g/L, sulphuric acid at a concentration of 0 g/L to 50 g/L and dissolved copper at a concentration of 0.1 g/L to 1 g/L;
c) wherein the leach solution comprises raffinate from a downstream solvent extraction and electrowinning (SX/EW) copper recovery process;
d) externally heating at least a portion of the leach solution prior to irrigation such that a temperature within the heap is maintained in the range of 30° C. to 50° C. during leaching; and
wherein irrigation is conducted at an average irrigation rate of less than or equal to 0.5 L/m²/h, the irrigation comprising continuous irrigation and/or intermittent irrigation including irrigation and rest cycles.

2. A method according to claim 1, wherein the ore comprises one or more minerals selected from chalcopyrite, bornite, carrollite, cubanite, enargite, tennantite and tetrahedrite.

3. A method according to claim 1, wherein the crushed ore has a particle size of 12.5 mm or less (100% passing 12.5 mm).

4. A method according to claim 1, wherein the heap is formed on a pad having an impermeable base.

5. A method according to claim 1, wherein the dissolved copper concentration is less than 0.5 g/L.

6. A method according to claim 1, wherein the leach solution comprises process water, brine, seawater, raffinate from a solvent extraction and electrowinning process, or a combination thereof.

7. A method according to claim 1, wherein chloride is provided by a chloride salt selected from NaCl, MgCl₂, KCl, AlCl₃, or mixtures thereof.

8. A method according to claim 1, wherein the leach solution comprises total dissolved iron in an amount of 0 g/L to 20 g/L.

9. A method according to claim 8, wherein the dissolved iron comprises Fe(II), Fe(III), or both.

10. A method according to claim 1 wherein the external heating is achieved by solar heating.

11. A method according to claim 10, wherein solar heating comprises a solar field and a heat exchanger and/or a heat pump.

12. A method according to claim 1, further comprising reducing heat loss by applying a thermal cover and/or insulating cover over at least a portion of the heap.

13. A method according to claim 1, wherein irrigation lines or drippers are buried in or under the heap to reduce heat loss.

14. A method according to claim 1, wherein the average irrigation rate of less than 0.5 L/m²/h is achieved by irrigation-rest cycling.

15. A method according to claim 14, wherein irrigation is conducted at a rate of less than 1 L/m²/h for 12 or 24 hours followed by a rest period of 12 or 24 hours.

16. A method according to claim 1, wherein the method is carried out without agglomeration.

17. A method according to claim 1, further comprising agglomerating crushed ore prior to stacking by adding a chloride salt in an amount of 0 kg/t to 50 kg/t, sulphuric acid in an amount of 0 kg/t to 50 kg/t, and water, raffinate, seawater, brine, process water, or a combination thereof, to form agglomerates.

18. A method according to claim 17, further comprising curing the agglomerated ore for a period of 7 to 30 days prior to stacking and irrigation.

19. A method according to claim 1, further comprising agglomerating crushed ore having a size of 100% passing 1 mm with a modified Ordinary Portland Cement (OPC) in the amount of 0-50 kg/t together with water.

20. A method according to claim 19 further comprising curing the agglomerated ore for a period of 30 days prior to stacking and irrigation.
